(19) United States
(12) Patent Application Publication
(10) Pub. No.: US 2021/0000067 A1
(43) Pub. Date: Jan. 7, 2021

(54) A FEEDING BOWL ASSEMBLY

(71) Applicant: Peak Pet Products Ltd, Ongar (GB)

(72) Inventor: Robert Philip PEACOCK, Coventry (GB)

(21) Appl. No.: 17/025,746

(22) Filed: Sep. 18, 2020

Related U.S. Application Data
(63) Continuation-in-part of application No. 16/614,702, filed on Nov. 18, 2019.

(30) Foreign Application Priority Data
May 20, 2016 (GB) 1608938.5
Sep. 19, 2019 (GB) 1913534.2

(51) Int. Cl. A01K 5/01

(52) U.S. Cl. CPC A01K 5/0135

(57) ABSTRACT

An animal feeding bowl assembly (101) for domestic pets, the bowl assembly (101) comprising: a bowl (102) for holding animal food (114) and/or drink, a support structure (116) for holding the bowl (102) in use in an assembled condition at an elevated position with reference to a ground or floor surface (118) on which the support structure (116) is located, the support structure (116) defining a cavity (120) below the bowl (102), in which cavity (120) is located, in use, a ballast material (122) for providing stability to the bowl assembly (101), the bowl assembly (101) having a height (28) and a width (30), in which the height (28) is greater than the width (30); the support structure (116) includes a support vessel (32), which defines an interior (34) in which the bowl (102) is located in the assembled condition, and the cavity (120) comprises a lowermost part of the interior (34).

### BACKGROUND OF THE INVENTION

### 1. Field of the Invention

The present invention relates to a feeding bowl assembly for feeding small domestic animals, in particular to a feeding bowl assembly comprising a feeding bowl and a base.

### 2. The Prior Art

Animals feeding bowls are often placed on flat, smooth floors. When an animal eats or drinks from the feeding bowl, the feeding bowl may be pushed around the floor by the animal, either intentionally or unintentionally. This movement can result in spillage of the food or water contained within the feeding bowl.

To address this problem, a known feeding bowl assembly comprises a feeding bowl releasably mountable to a weighted base. The feeding bowl can be unlocked from the base to be filled with food or water and then locked to the base to prevent it being moved around on the floor by an animal.

However, such a feeding bowl assembly has limited functionality and it may be difficult for elderly animal owners to unlock and lock the feeding bowl to the base. This can be particularly frustrating for the owner if the feeding bowl does not need to be locked to the base because their animal is inactive and/or weak and thus is unlikely knock the mounted feeding bowl off of the base.

Embodiments of the present invention seek to address the above problem and provide an improved feeding bowl assembly for use by both active and inactive animals.

### SUMMARY OF THE INVENTION

According to a first aspect of the present invention, there is provided an animal feeding bowl assembly comprising:

a feeding bowl comprising one or more connectors; and

a base comprising one or more complementary connectors,

wherein the feeding bowl is releasably mountable to the base in a locked orientation and an unlocked orientation relative to the base, and the one or more connectors and one or more complementary connectors are arranged such that in the locked orientation the feeding bowl is retained on the base by at least one of the one or more connectors engaging with at least one of the one or more complementary connectors.

In this way, the present invention provides an improved feeding bowl assembly in which the feeding bowl can be releasably mounted to the base to prevent the feeding bowl being moved around by the animal, in either an unlocked orientation or in a locked orientation. In the unlocked orientation, the feeding bowl is mounted to the base but not connected so it can be quickly and easily released therefrom. In the locked orientation, the one or more connectors on the feeding bowl automatically engage with the one or more complementary connectors on the base to securely lock the feeding bowl to the base. The provision of two different mounting orientations gives a user the choice of either locking or not locking the feeding bowl to the base. The locked orientation may be used, for example, to prevent boisterous and active animals from knocking the feeding bowl over, whereas the unlocked orientation may be used, for example, to prevent slow, lethargic or inactive animals from knocking the feeding bowl over, or by an elderly or weak user that cannot operate the connector mechanism. Thus, the feeding bowl assembly of the present invention provides improved functionality and practicality over known feeding bowl assemblies, such as the assembly described above, since it lets different users use the same feeding bowl assembly for different animals, whilst still retaining the relative advantages of each of the locked orientation and the unlocked orientation.

The feeding bowl assembly may be suitable for feeding small domestic animals such as cats and dogs.

The feeding bowl may comprise a body. The body may be substantially cuboidal. The body may thus have a substantially square cross section and may comprise four walls. The body may have rounded edges and/or corners between its walls. A cavity may be formed within the body for containing a portion of animal feed or water. The cavity may be cylindrical. The cavity may be formed concentrically with a longitudinal axis of the feeding bowl. The cavity may be formed in a top of the feeding bowl. The feeding bowl may be formed from a resilient material such as acrylonitrile butadiene styrene.

The feeding bowl may comprise any number of connectors. The feeding bowl may comprise an even number of connectors. For example, the feeding bowl may comprise two or four or six connectors. Each connector may comprise an engagement portion for engaging with a complementary connector on the base. The engagement portion may be planar. The engagement formation may project or protrude towards the centre of the cavity. The engagement formation may thus project or protrude towards the base when the feeding bowl is adjacent the base. Each connector may comprise a clip. Each connector may comprise one or more magnets. Each connector may be flexible.

The base may comprise a cavity. The base may comprise an opening for allowing the cavity to be filled with a substance. Thus, the base may act as a reservoir. The opening may be in the centre of a top part of the base. The opening may be circular. The substance may be a weight or ballast such as sand or water, or a mixture of sand and water. In this way, the reservoir can be filled with a substance to weigh it down and thus weigh down a mounted feeding bowl to prevent it being moved around by a feeding animal.

The base may comprise an outer rim formed around its circumference. The outer rim may provide a step formation. The base may be formed from high density polyethylene.

The base may comprise any number of complementary connectors. The base may comprise an even number of complementary connectors. For example, the base may comprise two or four or six complementary connectors. Each complementary connector may comprise a notch or indent in a wall of the base that projects or protrudes towards the centre of the base. Each complementary connector may comprise an engagement portion for engaging with the engagement portion on a connector on the feeding bowl. The engagement formation may be a lip. The engagement portion may be planar.. Each complementary connector may comprise one or more magnets.

The base may comprise one or more abutment portions. The base may comprise any number of abutment portions. The base may comprise an even number of abutment portions. For example, the base may comprise two or four or six abutment portions. Each abutment portion may be an indent in the outside wall of the base. Each abutment portion may have varying depth over its surface area. The varying depth may be greater at a bottom of the abutment portion than at a top of the abutment portion. Each abutment portion may be provided on a wall of the base that does not contain a complementary connector. Each abutment portion may comprise a planar surface contacting with a connector and allowing a connector to slide thereon. Each abutment portion may be arranged to contact with a connector when the feeding bowl is mounted in its unlocked orientation on the base.

The base may further comprise opening portions for contacting a connector before the connector engages with its complementary connectors. The base may comprise one or more opening portions. The base may comprise any number of opening portions. The base may comprise an even number of opening portions. Each opening portion may comprise an indent in the outside surface of a wall of the base. Each opening portion may be formed on a wall of the base on which a complementary connectors is formed. Each opening portion may comprise a vertical face. Each opening portion may comprise a ramp portion. The ramp portion may be inclined at 45° with respect to the vertical face. In this way, opening portions are provided to initially contact the connectors and make it easier for the user to lock the feeding bowl to the base.

One or more feet may be formed on a bottom of the base for reducing the surface area of the base in contact with a floor to assist in preventing the base from being moved on the floor. The base may preferably comprise four feet. Each of the feet may comprise a rubber portion for contacting the floor.

The feeding bowl assembly may further comprise a closure for sealing or closing the reservoir. The closure may comprise a screw thread engageable with a cooperating screw thread on a flange provided adjacent or on the opening. The closure may be formed from polypropylene.

The feeding bowl assembly and/or feeding bowl may comprise connectors of different sizes and/or shapes to one another. The feeding bowl assembly and/or base may comprise complementary connectors of different sizes and/or shapes to one another, which may correspond to sizes/shapes of the connectors. Thus, the feeding bowl assembly may comprise more than one engaging set of connectors and complementary connectors and each engaging set may be of a different size and/or shape. Thus, the differently sized/shaped sets of engaging connectors and complementary connectors may be arranged to engage with each other with different locking strengths. Accordingly, the one or more connectors and/or the one or more complementary connectors may be arranged such that the feeding bowl is releasably mountable to the base in additional orientations that provide additional locking strengths between the locking strengths of the locked orientation and the unlocked orientation. The one or more connectors and/or the one or more complementary connectors may be arranged such that the feeding bowl is releasably mountable to the base in the unlocked orientation and a plurality of locked orientations. The one or more connectors and/or the one or more complementary connectors may be arranged to lock the feeding bowl to the base with different locking strength in each of the plurality of locking orientations. For example, the one or more connectors engaging with the one or more complementary connectors to provide a first locked orientation may require a high strength to disengage and thus release the feeding bowl from the base, the one or more connectors engaging with the one or more complementary connectors to provide a second locked orientation may require a medium strength to disengage and thus release the feeding bowl from the base, and the one or more connectors engaging with the one or more complementary connectors to provide a third locked orientation may require a low strength to disengage and thus release the feeding bowl from the base. In this way, additional functionality is provided to allow a user to mount the feeding bowl to the base in different ways. For example, if the feeding bowl assembly has four sides then four different orientations can be provided (three locked orientations and an unlocked orientation). If the feeding bowl assembly is substantially cylindrical then more than four different orientations can be provided (more than three locked orientations and an unlocked orientation).

According to a second aspect of the present invention, there is provided an animal feeding bowl assembly for domestic pets, the bowl assembly comprising:

a bowl for holding animal food and/or drink,

a support structure for holding the bowl in use in an assembled condition at an elevated position with reference to a ground or floor surface on which the support structure is located,

the support structure defining a cavity below the bowl in which cavity is located, in use, a ballast material for providing stability to the bowl assembly.

Possibly, the bowl defines a food and/or drink receiving volume, in which, in use, the food and/or drink is located. Possibly, the cavity has a cavity volume, which may be greater than the food and/or drink receiving volume.

Possibly, the bowl assembly has a height and a width. Possibly, the height is greater than the width.

Possibly, the support structure includes a support vessel, which may define an interior, in which the bowl is located in the assembled condition.

Possibly, the cavity comprises a lowermost part of the interior.

Possibly, the support vessel is cylindrical and may include a base wall and one or more side walls which extend(s) upwardly from the base wall, possibly substantially vertically.

Possibly, the bowl is movable between the assembled condition and a disassembled condition, possibly by sliding. Possibly, in the disassembled condition, the bowl is wholly outside the interior.

Possibly, the support structure includes a bowl mounting, for mounting the bowl in the assembled condition. Possibly, the bowl mounting mounts the bowl above the cavity.

Possibly, the bowl mounting includes a mounting member, which in the assembled condition may extend across substantially the whole plan cross-sectional area of the interior, possibly to provide a cover for the cavity. Possibly, in the assembled condition, the bowl is located on the mounting member.

Possibly, the mounting member is movable between the assembled condition and a disassembled condition, possibly by sliding. Possibly, in the disassembled condition, the mounting member is wholly outside the interior.

Possibly, the mounting member comprises a closure part. The closure part may be in the form of a plate, which may be substantially planar. Possibly, the mounting member comprises a spacer part, which may be in the form of an inverted bowl.

Possibly, the mounting member comprises both the closure part and the spacer part, which may be fixed together or formed integrally.

Possibly, the side wall or walls define one or more release apertures. Possibly, the mounting member defines a release recess. Possibly, in the assembled condition, the or each release aperture and the release recess comprise a release passage, which may extend from the respective aperture to an underside of the bowl to permit the bowl to be released from the support vessel.

Possibly, the mounting member defines a filling aperture, which, in the assembled condition, may comprise a filling passage, which may extend from the or one of the release apertures to the filling aperture.

Possibly, the bowl mounting includes a mounting formation, which in the assembled condition supports the mounting member.

Possibly, the mounting formation comprises one or more protrusions which protrude inwardly into the interior from the side walls. Possibly, the protrusion is continuous around the interior. The mounting formation may comprise a band of material which may be fixed to and may extend around an inside surface of the side wall(s).

Possibly, the mounting formation comprises at least three of the protrusions, which may be equispaced.

Possibly, the support structure, and/or the support vessel, and/or the bowl, and/or the mounting member and/or the mounting formation are formed of metal, possibly stainless steel or aluminium and may be formed by processes comprising spinning and/or stamping and/or pressing.

Possibly, the bowl includes side walls which are angled upwardly and outwardly. Possibly, the side walls include top edges which are a sliding or interference fit within the support structure.

Possibly, the bowl includes a base wall and the spacer part includes a spacer top wall which is smaller than the bowl base wall. Possibly, the bowl base wall includes a release surface area. Possibly, in the assembled condition, the bowl base wall is located on the spacer top wall and the release surface area projects outwardly.

Possibly, the bowl assembly is circular in plan.

Possibly, the bowl assembly comprises domestic pet feeding bowl assembly and may comprise dog feeding bowl assembly.

According to a third aspect of the present invention, there is provided a method of feeding an animal such as a domestic pet, the method including providing animal feeding bowl assembly, the bowl assembly comprising:

a bowl for holding animal food and/or drink,

a support structure for holding the bowl in use in an assembled condition at an elevated position with reference to a ground or floor surface on which the support structure is located,

the support structure defining a cavity below the bowl in which is located, in use, a ballast material for providing stability to the bowl assembly.

Possibly, the bowl assembly includes any of the features described in any of the preceding statements or following description. Possibly, the method includes any of the steps described in any of the preceding statements or following description.

### BRIEF DESCRIPTION OF THE DRAWINGS

In order that the invention may be more clearly understood an embodiment thereof will now be described, by way of example only, with reference to the accompanying drawings, of which:

FIG. 1 is an exploded perspective view of a feeding bowl assembly according to a first embodiment of the present invention;

FIG. 2 is a perspective view of the feeding bowl assembly shown in FIG. 1, in which the feeding bowl has been mounted to the base;

FIG. 3 is a side cross-sectional view of the feeding bowl assembly shown in FIG. 2; the cross-section being at line Y in FIG. 2; and

FIG. 4 is a side cross-sectional view of the feeding bowl assembly shown in FIG. 2; the cross-section being at line X in FIG. 2.

FIG. 5 is a side cross-sectional view of a second embodiment of an animal feeding bowl assembly in an assembled condition; and

FIG. 6 is a side-cross sectional view of a third embodiment of the animal feeding bowl assembly in the assembled condition.

### DETAILED DESCRIPTION OF THE PREFERRED EMBODIMENTS

### First Embodiment

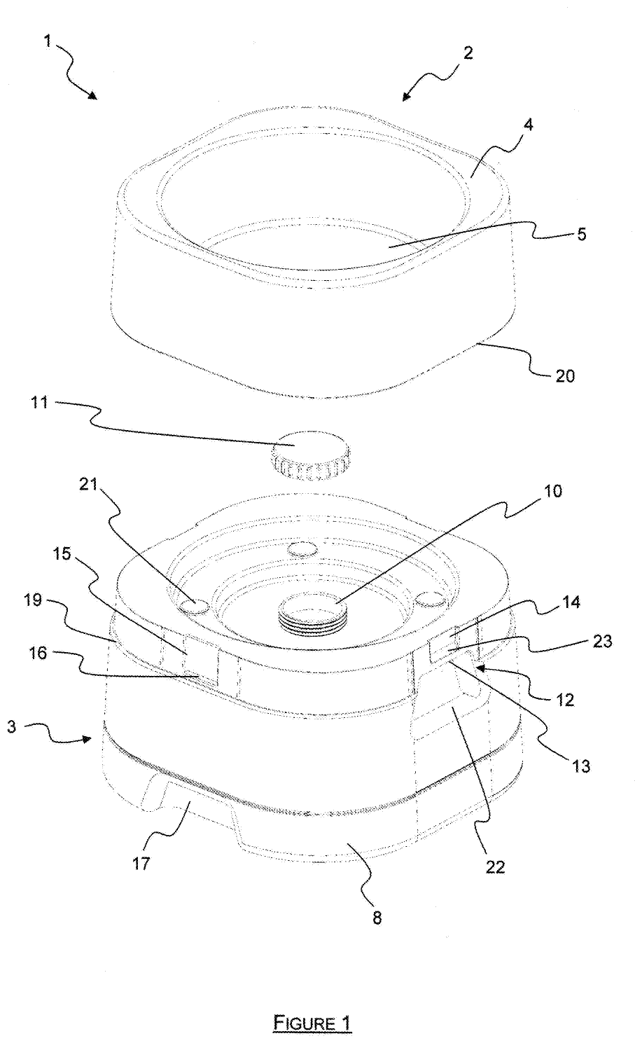

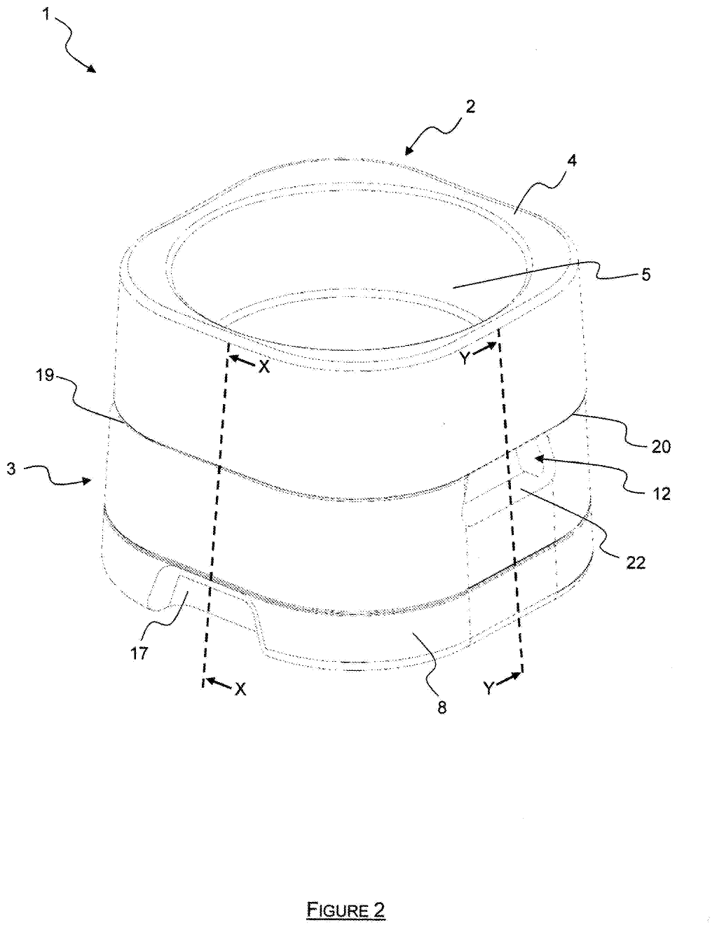

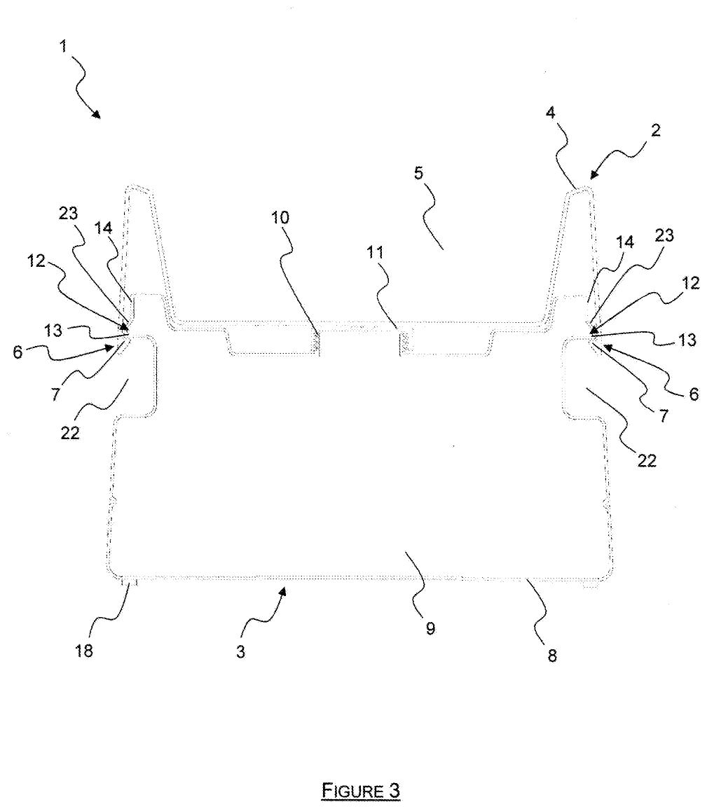

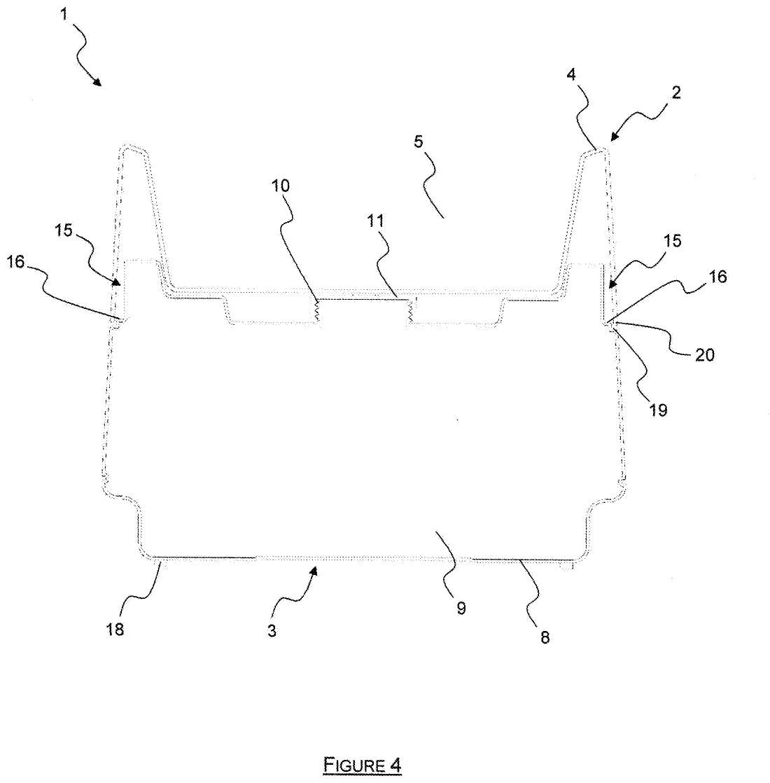

Referring to FIGS. 1 to 4, a feeding bowl assembly 1 comprises a feeding bowl 2 that is releasably mountable on a base 3. The feeding bowl 2 and base 3 both have substantially the same length and width.

The feeding bowl 2 comprises a substantially cuboidal body 4 having a substantially square cross section. The body 4 has rounded edges and comprises a cylindrical cavity 5 formed concentrically within the body 4. The body 4 comprises a lower edge 20 at the base of its walls.

The feeding bowl 2 comprises a pair of connectors 6 formed on opposing inside surfaces of the walls of the body 4. Each connector 6 is a formation having a planar engagement portion 7 that projects inwardly towards the centre of the cavity 5.

The feeding bowl 2 is formed from a resilient material such as acrylonitrile butadiene styrene such that the connectors 6 may flex.

The base 3 comprises a substantially cuboidal body 8. The base 3 is hollow, thus defining a cavity, and the cavity of the base 3 acts as reservoir 9 for storing ballast. The base 3 further comprises an opening 10 in the centre of a top surface. Four integrally formed upstands 21 are provided. The upstands 21 are cylindrical formations that protrude upwardly from the top surface of the base 3 and are arranged around the opening 10.

A closure 11 is provided and comprises a screw thread for engaging with a corresponding screw thread provided on a flange formed on the opening 10 in order to seal the reservoir 9 to contain the ballast in the base 3.

The base 3 further comprises two complementary connectors 12 and two abutment portions 15. The complementary connectors 12 are formed on opposing outside surfaces of the walls of the base 3. The abutment portions 15 are also formed on opposing outside surfaces of the walls of the base 3, on the walls of the base 3 that are perpendicular to the walls on which the complementary connectors 12 are formed (i.e. the walls of the base 3 on which the abutment portions 15 are formed are not the same walls of the base 3 on which the complementary connectors 12 are formed).

Each complementary connector 12 comprises a trapezoid shaped notch 22 that projects inwardly towards the centre of the reservoir 9, and a planar engagement portion 13 in the form of a lip at its top for engaging with the planar engagement formation 7 on a connector 6. The shape of each notch 22 allows for a user to engage their fingers with a locked connector 6 to release it from the base 3.

Each abutment portion 15 comprises a vertical indent that extends to the top of the base 3 and comprises a planar surface 16 for contacting with the planar engagement formation 7 on the connector 6. The depth of the indent in the wall of the base 3 decreases towards the top of the base 3 since the indent is vertical and the walls of the base 3 are slanted.

The base 3 further comprises a pair of opening portions 14. The opening portions are indents in the outside surface of the wall of the base 3 on which the complementary connectors 12 are formed. Each opening portion 14 comprises a vertical face and a ramp portion inclined at 45° with respect to the vertical face. The opening portions 14 are positioned above the complementary connectors 12 so as to contact the engagement portions 7 of the connectors 6 before the engagement formations 7 engage with engagement portions 13 of the complementary connectors 12.

The base 3 further comprises a protruding rim 19 formed around the circumference of the base 3. The rim 19 has an upper portion and a lower portion, with the upper portion having a smaller diameter than the lower portion so as to form a step. The base 3 further comprises a pair of handles 17 formed on the bottom of the outside surface of the same walls of the base 3 that the abutment portions 15 are formed. Each handle 17 is a is a trapezoid shaped notch that projects inwardly towards the centre of the reservoir 9 and is shaped so that it may be gripped by a user to allow the base 3 and/or feeding bowl assembly 1 to be moved.

Four feet 18 are formed on the bottom of the base 3, which reduces the surface area of the base 3 in contact with a floor to assist in preventing the base 3 from being pushed around. Each of the four feet 18 comprises a rubber portion for contacting the floor.

The base 3 is formed from high-density poly ethylene and the closure 11 is formed from polypropylene.

In use, the feeding bowl 2, base 3 and closure 11 are initially separate. The base 3 is placed in a suitable position on a floor. Ballast such as sand and/or water is poured through the opening 10 to fill the reservoir 9 to the desired level. The closure 11 is then secured to the opening 10 to seal the reservoir 9 by fully engaging the screw thread on the closure 11 with the cooperating screw thread provided on the opening 10.

Animal feed or water is then poured into the cavity 5 of the feeding bowl 2.

To mount the feeding bowl 2 to the base 3 in a locked orientation in which the feeding bowl 2 is locked securely to the base 3, the feeding bowl 2 is initially aligned concentrically with the base 3 and rotated to align the connectors 6 on the feeding bowl 2 with the complementary connectors 12 on the base 3. The feeding bowl 2 is then lowered on to the base 3. As the feeding bowl 2 is lowered, the engagement portion 7 of each connector 6 contacts with an opening portion 14. As each engagement portion 7 impinges on a ramp portion 23 of its contacted opening portion 14, the shape of the ramp portions 23 push the walls of the feeding bowl 2 on which the each connector 6 is formed to flex outwardly and displace the connectors 6 from the base 3. As the feeding bowl 2 is pressed further on to the base 3, the connectors 6 ride over the ramp portion 23 and the outside wall of the base 3 and are received into the notches 22 of the complementary connectors 12, allowing the walls of the feeding bowl 2 to snap back to their original non-flexed position. This action automatically engages the engagement portion 7 of each connector 6 with the engagement portion 13 of each complementary connector 12, which locks the feeding bowl 2 to the base 3. The bottom of the cavity 5 of the feeding bowl 2 abuts with each of the four upstands 21 of the base 3 to prevent the feeding bowl 2 from being pushed beyond this locked orientation. In this position, there is a small gap between the lower edge 20 of the feeding bowl 2 and the rim 19 of the base 3, around the circumference of the feeding bowl assembly 1.

To unlock and dismount the feeding bowl 2 from the base 3, a user inserts their fingers into each notch 22 and pulls the connectors 6 away from the complementary connectors 12, which flexes the walls of the feeding bowl 2 and disengages the engagement portion 7 of each connector 6 from the engagement portion 13 of the corresponding complementary connector 12. The feeding bowl 2 is then lifted upwards away from the floor and thus released from the separated base 3. The feeding bowl 2 can now be easily cleaned or refilled with food or water.

To mount the feeding bowl 2 to the base 3 in an unlocked orientation in which the feeding bowl 2 is secured to, but not locked to, the base 3, the feeding bowl 2 is initially aligned concentrically with the base 3 and rotated to align the connectors 6 on the feeding bowl 2 with the abutment portions 15 on the base 3 (which is 90° from the position when connectors 6 are aligned with the complementary connectors 12). The feeding bowl 2 is then lowered on to the base 3. As the feeding bowl 2 is lowered, the engagement portion 7 of each connector 6 on the feeding bowl 2 contacts with a top edge of an abutment portion 15, which causes the connected walls of the feeding bowl 2 to flex slightly outwardly and displace the connectors 6 from the base 3. As the feeding bowl 2 is pressed further on to the base 3, the engagement portion 7 of each connector 6 slides along the planer surface 16 of its contacted abutment portion 15 and is gradually received on to the planar surface 16 due to the varying depth of the abutment portion 15. The connector 6 is now received into the indent of the abutment portion 15, and thus the feeding bowl 2 is mounted to the base 3 in the unlocked orientation. The bottom of the cavity 5 of the feeding bowl 2 abuts with each of the four upstands 21 of the base 3 to prevent the feeding bowl 2 from being pushed beyond this unlocked orientation. In this position, there is a small gap between the lower edge 20 of the feeding bowl 2 and the rim 19 of the base 3, around the circumference of the feeding bowl assembly 1.

To dismount the feeding bowl 2 from the base 3, the feeding bowl 2 is simply lifted off of the base 3. The engagement portions 7 of the connectors 6 slide upwards along the planar surfaces 16 and the engagement portions 7 of the connectors 6 are pushed away from the base 3 so that the feeding bowl 2 can be dismounted and released from the base 3. The feeding bowl 2 can now be easily cleaned or refilled with food or water.

Accordingly, the present invention provides a feeding bowl assembly 1 in which the feeding bowl 2 can be mounted to the weighted base 3 to prevent the feeding animal from moving the feeding bowl 2 around on the floor. In addition, the feeding bowl 2 can be mounted to the base 3 in either a locked orientation or an unlocked orientation. This improves the functionality and usefulness of the feeding bowl assembly 1 since, for example, the locked orientation can be used with boisterous and active animals, whereas the unlocked orientation can be used with slow, lethargic or inactive animals, or by an elderly or weak user, whilst still securing the feeding bowl 2 to the base 3 to prevent it from being moved around by the animal.

The above embodiment is described by way of example only. Many variations are possible without departing from the scope of the invention as defined in the appended claims. For example, each connectors and complementary connector may comprise other cooperating arrangements such as each comprising one or more magnets.

### Second Embodiment

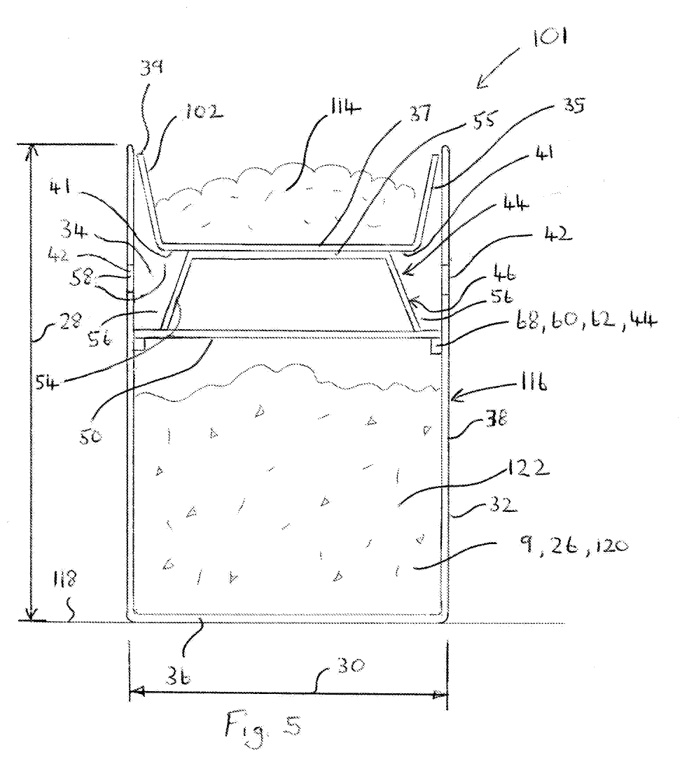

FIG. 5 shows a second embodiment of the invention, many features of which are similar to those already described in relation to the embodiment of FIGS. 1 to 4. Therefore, for the sake of brevity, the following embodiment will only be described in so far as it differs from the embodiment of FIGS. 1 to 4 already described. Where features are the same or similar, the same reference numerals have been used and the features will not be described again.

FIG. 5 shows an animal feeding bowl assembly 101 for domestic pets, the bowl assembly 101 comprising: a bowl 102 for holding animal food 114 and/or drink, and a support structure 116 for holding the bowl 102 in use in an assembled condition at an elevated position with reference to a ground or floor surface 118 on which the support structure 116 is located.

The support structure 116 (which is the equivalent to the base 3 of the previous embodiment) defines a cavity 120 below the bowl 102. The cavity 120 comprises a ballast reservoir 9, in which is located, in use, a ballast material 122 for providing stability to the bowl assembly 101.

The bowl 102 defines a food and/or drink receiving volume 24, in which, in use, the food and/or drink 114 is located. The cavity 120 has a cavity volume 26. In the example shown, the cavity volume 26 is greater than the food and/or drink receiving volume 24.

The bowl assembly 101 has a height 28 and a width 30. The height 28 is greater than the width 30.

The support structure 116 includes a support vessel 32, which defines an interior 34, in which the bowl 102 is located in the assembled condition.

In the example shown, in the assembled condition, the bowl 102 is wholly located in the interior 34.

The cavity 120 comprises a lowermost part of the interior 34.

The support vessel 32 is cylindrical and includes a base wall 36 and, in this example, one side wall 38 which extends vertically upwardly from the base wall 36, the side wall 38 extending continuously around the interior 34. In the example shown, the side wall 38 extends the whole of the height 28. The external surface of the side wall 38 is without any outward projections, which reduces the risk of a pet trying to climb the side wall 38.

The bowl 102 is slidably movable between the assembled condition and a disassembled condition. In the disassembled condition, the bowl 102 is wholly outside the interior.

The side wall 38 defines one or more release apertures 42. The mounting member 46 defines a release recess 56. In the assembled condition, the or each release aperture 42 and the release recess 56 comprise a release passage 58, which extends from the respective aperture 42 to an underside of the bowl 102 to permit the bowl 102 to be released from the support vessel 32.

The release apertures 42 also provide lifting apertures to aid in lifting the whole of the bowl assembly 101.

The support structure 116 includes a bowl mounting 44, for mounting the bowl 102 in the assembled condition. The bowl mounting 44 mounts the bowl 102 above the cavity 120.

In the example shown, the bowl mounting 44 is located wholly within the interior 34.

The bowl mounting 44 includes a mounting member 46, which in the assembled condition extends across substantially the whole plan cross-sectional area of the interior 34, to provide a cover for the cavity 20. In the assembled condition, the bowl 102 is located on the mounting member 46.

The mounting member 46 is slidably movable between the assembled condition and the disassembled condition. In the disassembled condition, the mounting member 46 is wholly outside the interior 34.

The mounting member 46 comprises a closure part 50, which, in the assembled condition, closes the cavity 120. The closure part 50 is in the form of a substantially planar plate.

The mounting member 46 comprises a spacer part 54, which spaces the bowl 102 upwardly from the ground or floor surface 118. The spacer part 54 is in the form of an inverted bowl.

In the example shown, the mounting member 46 comprises both the closure part 50 and the spacer part 54, which could be permanently fixed together (for example, by welding, adhesive, or any other convenient method) or could be formed integrally.

The mounting member 46 defines a release recess 56, which, in the assembled condition, comprises a release passage 58. The release passage 58 extends from the release apertures 42 to an underside of the bowl 102.

The bowl mounting 44 includes a mounting formation 60, which in the assembled condition supports the mounting member 46.

The mounting formation 60 could comprise one or more protrusions 62 which protrude inwardly into the interior 34 from the side wall 38. In the example shown, the mounting formation 60 comprises one protrusion 62 which is continuous around the interior 34. The mounting formation 60 comprises a band 68 of material which is fixed to and extends around an inside surface of the side wall 38.

The bowl 102 includes side walls 35 which are angled upwardly and outwardly. The side walls 35 include top edges 39 which are a sliding or interference fit within the support structure 116.

The bowl 102 includes a base wall 37 and the spacer part 54 includes a spacer top wall 55 which is smaller than the bowl base wall 37. The bowl base wall 37 includes a release surface area 41. In the assembled condition, the bowl base wall 37 is located on the spacer top wall 55 and the release surface area 41 projects outwardly, on the underside of the bowl base wall 37.

The support vessel 32, the bowl 102, the mounting member 46 and the mounting formation 60 are formed of metal, for example, stainless steel or aluminium and could be formed by processes comprising spinning, stamping and pressing.

In one example, the bowl assembly 10 is circular in plan.

The bowl assembly 10 comprises a domestic pet feeding bowl assembly and could comprise a dog feeding bowl assembly.

### Second Embodiment In Use

In a disassembled condition, the bowl 102 and the mounting member 46 are separated from the vessel 32 and wholly outside of the interior 34 and the cavity 120 is open. The ballast material 122 is then located in the cavity 120, ie in the bottom of the interior 34. The ballast material 122 could comprise any suitable weighting material for providing weight, for example, sand, aggregate, stone and/or water. However, it is not recommended to use the cavity 120 for food storage as depletion of the food in the cavity 120 can lead to instability. Also, pets can learn that food is stored in the cavity 120 and then try to access the cavity. By using an inert, stable, smell free ballast material, it is not necessary to provide an air-tight seal to the cavity 120, thus reducing costs.

The mounting member 46 is then located to sit on the mounting formation 60, so that the closure part 50 substantially closes the cavity 120, preventing escape of the ballast material 122 and contamination of the ballast material 122. The bowl 102 is then located on to the top of the spacer part 54 of the mounting member 46.

The bowl assembly 10 is arranged so that the rim or upper edge of the bowl 102 is located just below the level of the rim or upper edge of the vessel 32, for stability. In one example, the rim of the bowl 102 is approximately 1 cm below the rim of the vessel 32. Also, the rim of the bowl 102 is a close fit within the side wall 38 of the vessel 32. These features make it difficult to remove the bowl 102 from the interior 34 from above, since it cannot be removed at an angle. This prevents or at least reduces the risk that a dog will grip one side of the bowl 102 and be able to remove it from the vessel 32.

The bowl assembly 10 is now in the assembled condition. Foodstuff or water (or both if the bowl 102 has a divider) can then be located in the food and/or drink receiving volume 24.

To remove the bowl 102, a user can pass fingers (or other convenient elongate tools) through two of the release apertures 42 along the release passages 58 to push upwardly on the release surface area 41 on the underside of the bowl 102 to slidably move the bowl 102 upward and out of the interior 34. With the bowl 102 released, the mounting member 46 can be slidably upwardly and moved out of the interior 34 if required.

Advantageously, the height 28 of the bowl assembly 101 is larger than its width 30, to cater for larger animals without taking excessive floor space. The relatively greater height 28 is permitted by the increased stabilising effect of the enlarged cavity 120 relative to the food and/or drink receiving volume 24. The vertical side wall 38 minimises floor space.

Advantageously, the bowl 102 is not held in place by clips or catches but simply slides in and out of position, making use easy for the elderly, reducing complexity and thus reducing cost.

Advantageously, the components of the bowl assembly 101 can be formed of metal, which has better resistance to dog bites and chewing and thus stays hygienic for longer, and this gives longer product life.

### Third Embodiment

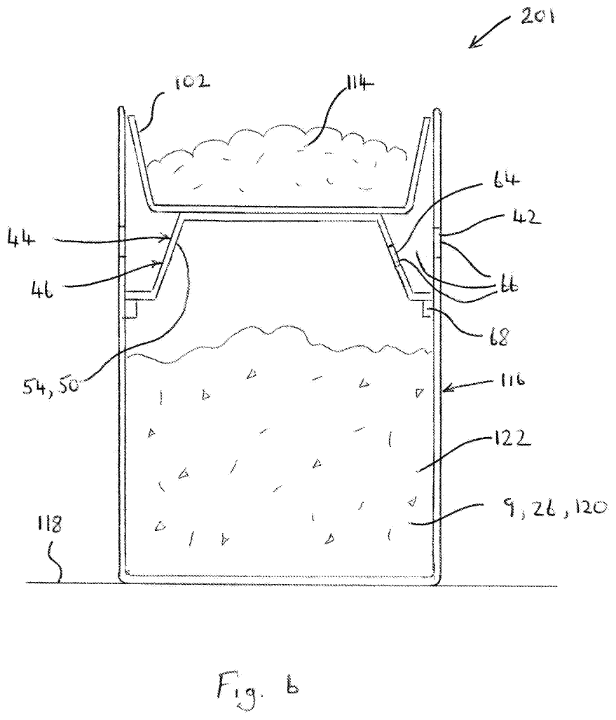

FIG. 6 shows another embodiment of the invention, many features of which are similar to those already described in relation to the embodiment of FIG. 5. Therefore, for the sake of brevity, the following embodiment will only be described in so far as it differs from the embodiment of FIG. 5 already described. Where features are the same or similar, the same reference numerals have been used and the features will not be described again.

FIG. 6 shows a second animal feeding bowl assembly 201 in which the mounting member 46 is in the form of an inverted bowl which comprises both the spacer part 54 and the closure part 50. The mounting member 46 defines a filling aperture 64. In the assembled condition, the filling aperture 64 comprises part of a filling passage 66, which extends from (and includes) one of the release apertures 42 to the filling aperture 64.

In use, with the bowl assembly 210 in the assembled condition, the cavity 120 can be filled by inserting a pipe or tube along the filling passage 66. This avoids having to disassemble the bowl assembly 210.

### Other Modifications

Various other modifications could be made without departing from the scope of the invention. The bowl assembly and its components could be of any suitable size and shape, and could be formed of any suitable material (within the scope of the specific definitions herein).

In one example, the mounting formation 60 could comprise at least three of the protrusions 62, which could be equispaced.

Any of the features or steps of any of the embodiments shown or described could be combined in any suitable way, within the scope of the overall disclosure of this document.

What is claimed is:

1. An animal feeding bowl assembly for domestic pets, the bowl assembly comprising:
a bowl for holding animal food and/or drink; and
a support structure for holding the bowl in use in an assembled condition at an elevated position with reference to a ground or floor surface on which the support structure is located;
wherein the support structure defining a cavity below the bowl, in which cavity is located, in use, a ballast material for providing stability to the bowl assembly, and
wherein the bowl assembly having a height and a width, in which the height is greater than the width; the support structure includes a support vessel, which defines an interior, in which the bowl is located in the assembled condition, and the cavity comprises a lowermost part of the interior.

2. The assembly according to claim 1, in which, in the assembled condition, the bowl is wholly located in the interior.

3. The assembly according to claim 1, in which the support vessel is cylindrical and includes a base wall and one or more side walls which extend(s) substantially vertically upwardly from the base wall.

4. The assembly according to claim 1, in which the support structure includes a bowl mounting, for mounting the bowl in the assembled condition above the cavity; the bowl mounting includes a removable mounting member, which in the assembled condition extends across substantially the whole plan cross-sectional area of the interior, to provide a cover for the cavity.

5. The assembly according to claim 4, in which the mounting member comprises a closure part for closing the cavity; the closure part is in the form of a plate and is substantially planar.

6. The assembly according to claim 4, in which the mounting member comprises a spacer part, which is in the form of an inverted bowl.

7. The assembly according to claim 4, in which the mounting member comprises a closure part for closing the cavity; the closure part is in the form of a plate and is substantially planar; the mounting member comprises a spacer part, which is in the form of an inverted bowl; and the closure part and the spacer part are fixed together or formed integrally.

8. The assembly according to claim 4, in which the support vessel includes a base wall and one or more side walls, and the side wall or walls define one or more release apertures; the mounting member defines a release recess; in the assembled condition, the or each release aperture and the release recess comprise a release passage, which extends from the respective aperture to an underside of the bowl to permit the bowl to be released from the support vessel.

9. The assembly according to claim 8, in which the mounting member defines a filling aperture, which, in the assembled condition, comprises a filling passage, which extends from the or one of the release apertures to the filling aperture.

10. The assembly according to claim 4, in which the bowl mounting includes a mounting formation, which in the assembled condition supports the mounting member; the mounting formation comprises one or more protrusions which protrude inwardly into the interior from the side walls.

11. The assembly according to claim 10, in which the protrusion is continuous around the interior.

12. The assembly according to claim 10, in which the mounting formation comprises at least three of the protrusions.

13. The assembly according to claim 1, in which the bowl includes side walls which are angled upwardly and outwardly, and the side walls include top edges which are a sliding or interference fit within the support structure.

14. The assembly according to claim 6, in which the bowl includes a base wall and the spacer part includes a spacer top wall which is smaller than the bowl base wall; the bowl base wall includes a release surface area; in the assembled condition, the bowl base wall is located on the spacer top wall and the release surface area projects outwardly from the spacer top wall.

15. The assembly according to claim 1, in which the bowl assembly is circular in plan.

16. The assembly according to claim 1, in which the bowl assembly comprises a dog feeding bowl assembly.

17. A method of feeding an animal such as a domestic pet, the method including providing an animal feeding bowl assembly, the bowl assembly comprising:
a bowl for holding animal food and/or drink; and
a support structure for holding the bowl in use in an assembled condition at an elevated position with reference to a ground or floor surface on which the support structure is located;
wherein the support structure defining a cavity below the bowl, in which cavity is located, in use, a ballast material for providing stability to the bowl assembly, and
wherein the bowl assembly having a height and a width, in which the height is greater than the width; the support structure includes a support vessel, which defines an interior, in which the bowl is located in the assembled condition, and the cavity comprises a lowermost part of the interior.
